(19) United States
(12) Patent Application Publication
(10) Pub. No.: US 2015/0371256 A1
(43) Pub. Date: Dec. 24, 2015

(54) SYSTEMS, METHODS, AND APPARATUS FOR IN-STORE ANALYTICS AND OFFLINE ATTRIBUTION

(71) Applicant: TURN INC., REDWOOD CITY, CA (US)

(72) Inventors: Neil Shah, Redwood City, CA (US); Ali Ahmed, Redwood City, CA (US); Lawrence Lo, Redwood City, CA (US)

(73) Assignee: TURN INC., REDWOOD CITY, CA (US)

(21) Appl. No.: 14/308,295

(22) Filed: Jun. 18, 2014

(51) Int. Cl. G06Q 30/02

(52) U.S. Cl. CPC G06Q 30/0242; G06Q 30/0267; G06Q 30/0268

(57) ABSTRACT

Systems, methods, and apparatus are disclosed herein for correlating offline and online user activity. The methods may include receiving a first communication including first event data. The first event data may characterize an interaction between a mobile device and a location-based transmitter. The location-based transmitter may be associated with a transmitter identifier and a location. The methods may also include updating, using one or more processors, a first user profile based on the first event data included in the first communication. The first user profile may characterize information associated with a user of the mobile device. The first user profile may include one or more data values representing a plurality of events and actions associated with the user. The first user profile may be capable of being used to provide advertisements to the user.

### TECHNICAL FIELD

This disclosure generally relates to online advertising, and more specifically to analytics and attribution associated with advertising.

### BACKGROUND

In online advertising, internet users are presented with advertisements as they browse the internet using a web browser or mobile application. Online advertising is an efficient way for advertisers to convey advertising information to potential purchasers of goods and services. It is also an efficient tool for non-profit/political organizations to increase the awareness in a target group of people. The presentation of an advertisement to a single internet user is referred to as an ad impression.

Billions of display ad impressions are purchased on a daily basis through public auctions hosted by real time bidding (RTB) exchanges. In many instances, a decision by an advertiser regarding whether to submit a bid for a selected RTB ad request is made in milliseconds. Advertisers often try to buy a set of ad impressions to reach as many targeted users as possible. Advertisers may seek an advertiser-specific action from advertisement viewers. For instance, an advertiser may seek to have an advertisement viewer purchase a product, fill out a form, sign up for e-mails, and/or perform some other type of action. An action desired by the advertiser may also be referred to as a conversion.

### SUMMARY

Systems, methods, and apparatus are disclosed herein for analytics and attribution associated with online and offline advertising. In various embodiments, the methods may include receiving a first communication including first event data. The first event data may characterize an interaction between a mobile device and a location-based transmitter. The location-based transmitter may be associated with a transmitter identifier and a location. The methods may also include updating, using one or more processors, a first user profile based on the first event data included in the first communication. The first user profile may characterize information associated with a user of the mobile device. The first user profile may include one or more data values representing a plurality of events and actions associated with the user. Moreover, the first user profile may be accessible for being used to provide advertisements to the user.

In some embodiments, the first event data includes a time stamp, the transmitter identifier, and a device identifier associated with the mobile device. According to some embodiments, the first event data is generated, at least in part, by an application executed on the mobile device, and the first event data is generated in response to the mobile device being within a designated distance of the location-based transmitter. In some embodiments, the methods may further include mapping the device identifier and the transmitter identifier to the user profile. The method may also include receiving a second communication including second event data identifying an action associated with a point of sale, where the action is associated with a purchase transaction. In some embodiments, the first event data is generated in response to the mobile device being within a designated distance of the location-based transmitter, and the location-based transmitter is located at the point of sale. In some embodiments, the updating of the first user profile further includes merging the first event data with the second event data based, at least in part, on a first set of identifiers associated with the first event data and a second set of identifiers associated with the second event data.

According to some embodiments, the methods further include providing a third communication to the point of sale, where the third communication includes one or more data values capable of modifying the purchase transaction. The methods may also include identifying a second user profile associated with the first user profile based on a correlation between second event data associated with the second user profile and the first event data associated with the first user profile. The methods may also include generating a merged profile by mapping one or more data fields of the first user profile to one or more data fields of the second user profile. In some embodiments, the methods may further include generating at least one performance metric based on the first user profile, where the performance metric identifies one or more performance characteristics of an advertisement campaign associated with the first user profile. In some embodiments, the performance metric identifies a return-on-investment associated with the advertisement campaign. The methods may also include generating a graphical representation of the first event data, where the graphical representation is capable of being displayed as a component of a user interface screen on a display device.

Also disclosed herein are systems including one or more servers configured to store data associated with a plurality of users. The systems may further include one or more processors configured to execute one or more instructions to receive a first communication including first event data, where the first event data characterizes an interaction between a mobile device and a location-based transmitter, and where the location-based transmitter is associated with a transmitter identifier and a location. The one or more processors may be further configured to update a first user profile based on the first event data included in the first communication, where the first user profile characterizes information associated with a user of the mobile device, where the first user profile includes one or more data values representing a plurality of events and actions associated with the user, and where the first user profile is accessible for being used to provide advertisements to the user.

In some embodiments, the first event data includes a time stamp, the transmitter identifier, and a device identifier associated with the mobile device. Moreover, the first event data may be generated, at least in part, by an application executed on the mobile device, and the first event data may be generated in response to the mobile device being within a designated distance of the location-based transmitter. In some embodiments, the one or more processors are further configured to receive a second communication including second event data identifying an action associated with a point of sale, where the action is associated with a purchase transaction. In various embodiments, the first event data is generated in response to the mobile device being within a designated distance of the location-based transmitter, where the location-based transmitter is located at the point of sale. In some embodiments, the updating of the first user profile further includes merging the first event data with the second event data based, at least in part, on a first set of identifiers associated with the first event data and a second set of identifiers associated with the second event data. In some embodiments, the one or more processors are further configured to provide a third communication to the point of sale, where the third communication includes one or more data values capable of modifying the purchase transaction. In some embodiments, the one or more processors are further configured to identify a second user profile associated with the first user profile based on a correlation between second event data associated with the second user profile and the first event data associated with the first user profile. In various embodiments, the one or more processors are further configured to generate a merged profile by mapping one or more data fields of the first user profile to one or more data fields of the second user profile.

Further disclosed herein are one or more computer readable media having instructions stored thereon for performing a method, the method including receiving a first communication including first event data, where the first event data characterizes an interaction between a mobile device and a location-based transmitter, and where the location-based transmitter is associated with a transmitter identifier and a location. The methods may also include updating a first user profile based on the first event data included in the first communication, where the first user profile characterizes information associated with a user of the mobile device, where the first user profile includes one or more data values representing a plurality of events and actions associated with the user, and where the first user profile is accessible for being used to provide advertisements to the user. In some embodiments, the methods further include receiving a second communication including second event data identifying an action associated with a point of sale, where the action is associated with a purchase transaction.

Details of one or more embodiments of the subject matter described in this specification are set forth in the accompanying drawings and the description below. Other features, aspects, and advantages will become apparent from the description, the drawings, and the claims.

### BRIEF DESCRIPTION OF THE DRAWINGS

FIG. 1 illustrates an example of a system for correlating mobile device and user data with a location-based transmitter, implemented in accordance with some embodiments.

FIG. 2 illustrates an example of an advertiser hierarchy, implemented in accordance with some embodiments.

FIG. 3 illustrates a flow chart of an example of a user profile updating method, implemented in accordance with some embodiments.

FIG. 4 illustrates a flow chart of another example of a user profile updating method, implemented in accordance with some embodiments.

FIG. 5 illustrates a flow chart of another example of a user profile updating method, implemented in accordance with some embodiments.

FIG. 6 illustrates a flow chart of an example of a data analytics method, implemented in accordance with some embodiments.

FIG. 7 illustrates a data processing system configured in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific examples, it will be understood that these examples are not intended to be limiting.

In online advertising, it is preferable to provide the best ad for a given user in an online context. Advertisers often set constraints which affect the applicability of the advertisements. For example, an advertiser might want to target only users in a particular geographical area or region who may be visiting web pages of particular types for a specific campaign. As used herein, a campaign may be an advertisement strategy or campaign which may be implemented across one or more channels of communication. Furthermore, the objective of advertisers may be to receive as many user actions as possible by utilizing different campaigns in parallel. As previously discussed, an action may be the purchase of a product, filling out of a form, signing up for e-mails, and/or some other type of action. In some embodiments, actions or user actions may be advertiser defined and may include an affirmative act performed by a user, such as inquiring about or purchasing a product and/or visiting a certain page.

In various embodiments, an ad from an advertiser may be shown to a user with respect to publisher content, which may be a website or mobile application if the value for the ad impression opportunity is high enough to win in a real-time auction. Advertisers may determine a value associated with an ad impression opportunity by determining a bid. In some embodiments, such a value or bid may be determined based on the probability of receiving an action from a user in a certain online context multiplied by the cost-per-action goal an advertiser wants to achieve. Once an advertiser, or one or more demand-side platforms that act on their behalf, wins the auction, it is responsible to pay the amount that is the winning bid. Accordingly, each advertiser needs to carefully manage their budget to maximize their capability or potential to bid.

Conventional techniques for implementing advertisement campaigns and assessing value returned by such advertisement campaigns do not account for offline activity that may occur in conjunction with online activity. For example, if a user sees several advertisements online and subsequently purchases a product in a store, the subsequent purchase in the store is not recorded and is not associated with the other advertisement views. Thus, purchases of products and other actions that may be performed by a user in an “offline” context, which may be at a physical location such as a retail store, are not monitored by conventional techniques, and are not incorporated in conventional techniques for attributing actions to advertisement campaigns and assessing a value returned by the advertisement campaigns based on such attributions.

Various systems, methods, and apparatus disclosed herein correlate online and offline activity to provide a unified view of a user's activity as it relates to various advertisement campaigns. According to various embodiments, a campaign services provider, such as Turn™ of Redwood City, Calif., may manage the implementation of various advertisement campaigns and the storage of various data associated with users targeted by those advertisement campaigns. In various embodiments, the campaign services provider may receive event data from various sources. The event data may describe or characterize interactions between a user or the user's mobile device and an entity which may be located at a particular physical location. As will be discussed in greater detail below, the entity may be a location-based transmitter or other location entity. Thus, the campaign services provider may receive various information characterizing and describing interactions between the user and other entities at a physical location. The received information may also identify actions taken by the user, such as the purchase of a product. The campaign services provider may merge this received information with other information describing the user's activities in an online context, such as online advertisements viewed and clicked on by the user. In this way, the campaign services provider may merge the offline and online data to more accurately represent actions taken by a user, as well as the events leading up to the actions. In this way, the campaign services provider may more accurately attribute online and offline actions to advertisement campaigns.

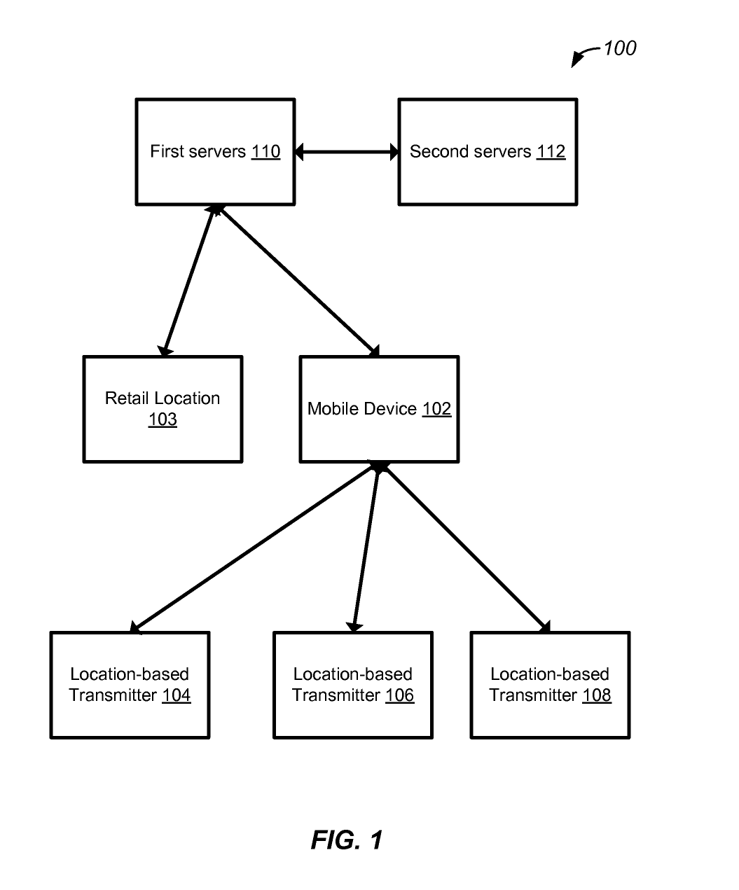

FIG. 1 illustrates an example of a system for correlating mobile device and user data with a location-based transmitter, implemented in accordance with some embodiments. As similarly discussed above, systems as described herein, such as system 100 may be implemented to correlate online user activity with offline user activity. As previously discussed, the offline activity may take place in an offline commercial context at a location such as a retail location which may be a department store or shopping mall. It will be appreciated that while reference is made herein to offline activity, such activity might not be entirely offline and may implement various network and internet connections to perform one or more commercial transactions, or various events or actions associated with the one or more commercial transactions. Thus, offline activity may refer to activity in which the user is physically present at a location such as retail location 103 which may include a point of sale. Online activity may take place in an online context which may include online shopping and purchasing via the internet using one or more browsers or applications, which may be implemented across multiple devices, such as computers and other mobile devices. Various components of system 100 may be implemented to effectively correlate or link the offline activity with the online activity to generate a merged and unified view of the user's activities. Furthermore, positional data included in or associated with the offline data may be provided by location-based transmitters and may form the basis of linking the offline activity with the online activity as will be discussed in greater detail below.

Accordingly, system 100 may include a mobile device, such as mobile device 102, which may be a computing device that includes software and hardware configured to execute various software applications. For example, mobile device 102 may include computer processor(s) and an operating system configured to execute a software application which may be a mobile application. Accordingly, mobile device 102 may be a handheld computer, smartphone, personal digital assistant (PDA), game or other entertainment system, or a tablet personal computer (PC). Moreover, mobile device 102 may include various communications interfaces configured to provide various input and output functionalities. For example, mobile device 102 may include communications interfaces configured to receive inputs from a user, such as a touchscreen, keyboard, or microphone. Furthermore, mobile device 102 may include communications interfaces configured to provide wireless connectivity with various other data processing entities. For example, mobile device 102 may include communications interfaces configured to send and receive data via Wi-Fi™, Bluetooth™, and Global Positioning System (GPS) modalities. While system 100 shows one mobile device, system 100 may include multiple mobile devices. Accordingly, the features provided by system 100 may be provided to multiple mobile devices and multiple users associated with those mobile devices.

System 100 may include multiple location-based transmitters, such as location-based transmitter 104, location-based transmitter 106, and location-based transmitter 108. In various embodiments, a location-based transmitter may be a low-powered transmitter configured to transmit data within a designated distance, radius, or proximity of the location-based transmitter. For example, a location-based transmitter may be a transmitter such as an Estimote™ beacon. In some embodiments, each location-based transmitter may be identified by a unique identifier which may be referred to herein as a transmitter identifier. Each location-based transmitter may be configured to broadcast or transmit its transmitter identifier within its designated transmission distance or proximity. In some embodiments, the transmitter identifier may be transmitted via a wireless communications modality such as Wi-Fi™ or Bluetooth™. In this way, data may be transmitted between mobile device 102 and each of location-based transmitter 104, location-based transmitter 106, and location-based transmitter 108 when mobile device 102 is within each of their respective transmission distance. For example, when mobile device 102 is within a transmission distance of location-based transmitter 104, a wireless connection may be established, and location-based transmitter 104 may transmit its unique transmitter identifier to mobile device 102.

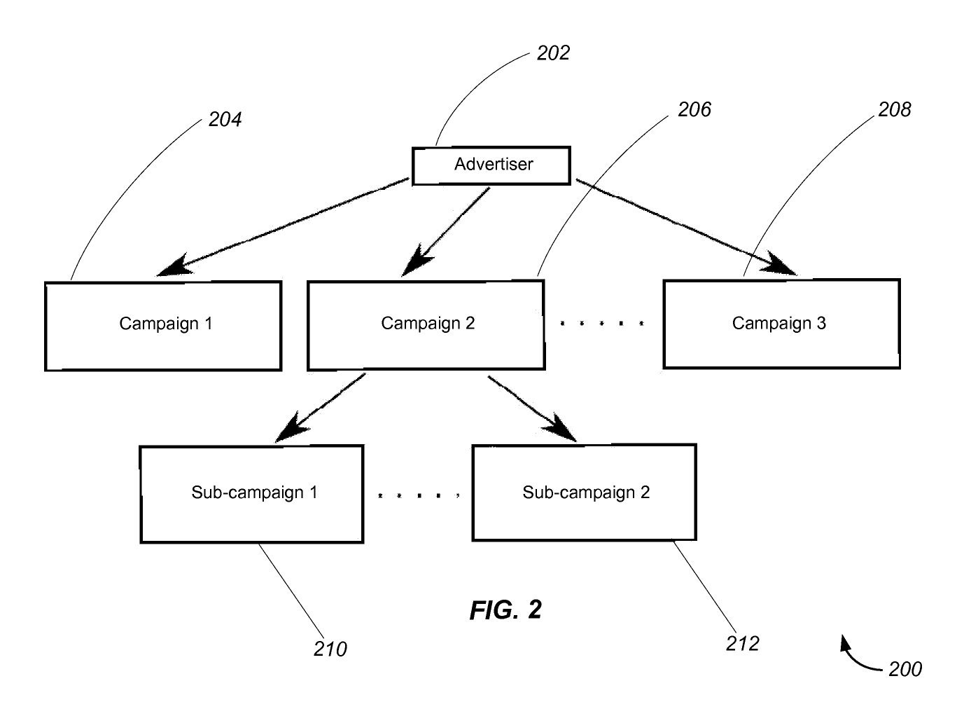

In some embodiments, system 100 also includes first servers 110 which may include one or more servers, such as a control server, which may be configured to manage and maintain data associated with advertisement campaigns that may be implemented via system 100. As discussed in greater detail below with reference to FIG. 2, first servers 110 may include advertisement servers which may be configured to manage and implement bid requests associated with the various advertisement campaigns. For example, first servers 110 may manage the allocation of budgets among campaigns as well as their various sub-components. Furthermore, first servers 110 may be configured to manage the issuance of bid requests based on the previously-described allocated budgets. Further still, first servers 110 may be configured to manage the receipt and processing of communications or messages that identify events and actions associated with the advertisement campaigns.

System 100 may also include second servers 112 which may include one or more servers configured to manage and maintain data related to users associated with the advertisement campaigns maintained and managed by first servers 110. Thus, various user profiles may be stored and maintained by second servers 112. In some embodiments, each of the user profiles may include a unique identifier associated with a user that may be referred to herein as a user identifier. Moreover, the user profiles may further include various data characterizing events and actions that have been performed or experienced by the user. For example, a user profile may store in a data object a sequential representation of a several events that may have led to an action. In this example, the events may each be the presentation of an online advertisement. Moreover, the action may be the purchase of a product. The sequential representation may also store various metadata, such as time stamps, associated with each event and action. In various embodiments, the data included the user profiles may be received or aggregated from various sources associated with the user, such as the user's mobile devices, computers, computer browsers, and third party servers associated with the use of such devices. Moreover, such data may also be received from third party data providers. Additional details regarding the interactions between first servers 110, second servers 112, mobile device 102, and location-based transmitters will be described in greater detail with reference to FIGS. 2-7 below.

FIG. 2 illustrates an example of an advertiser hierarchy, implemented in accordance with some embodiments. As previously discussed, advertisement servers may be used to implement various advertisement campaigns to target various users or an audience. In the context of online advertising, an advertiser, such as the advertiser 202, may display or provide an advertisement to a user via a publisher, which may be a web site, a mobile application, or other browser or application capable of displaying online advertisements. The advertiser 202 may attempt to achieve the highest number of user actions for a particular amount of money spent, thus maximizing the return on the amount of money spent. Accordingly, the advertiser 202 may create various different tactics or strategies to target different users. Such different tactics and/or strategies may be implemented as different advertisement campaigns, such as campaign 204, campaign 206, and campaign 208, and/or may be implemented within the same campaign. Each of the campaigns and their associated sub-campaigns may have different targeting rules. For example, a sports goods company may decide to set up a campaign, such as campaign 204, to show golf equipment advertisements to users above a certain age or income, while the advertiser may establish another campaign, such as campaign 206, to provide sneaker advertisements towards a wider audience having no age or income restrictions. Thus, advertisers may have different campaigns for different types of products. The campaigns may also be referred to herein as insertion orders.

Each campaign may include multiple different sub-campaigns to implement different targeting strategies within a single advertisement campaign. In some embodiments, the use of different targeting strategies within a campaign may establish a hierarchy within an advertisement campaign. Thus, each campaign may include sub-campaigns which may be for the same product, but may include different targeting criteria and/or may use different communications or media channels. Some examples of channels may be different social networks, streaming video providers, mobile applications, and web sites. For example, the sub-campaign 210 may include one or more targeting rules that configure or direct the sub-campaign 210 towards an age group of 18-34 year old males that use a particular social media network, while the sub-campaign 212 may include one or more targeting rules that configure or direct the sub-campaign 212 towards female users of a particular mobile application. As similarly stated above, the sub-campaigns may also be referred to herein as line items.

Accordingly, an advertiser 202 may have multiple different advertisement campaigns associated with different products. Each of the campaigns may include multiple sub-campaigns or line items that may each have different targeting criteria. Moreover, each campaign may have an associated budget which is distributed amongst the sub-campaigns included within the campaign to provide users or targets with the advertising content.

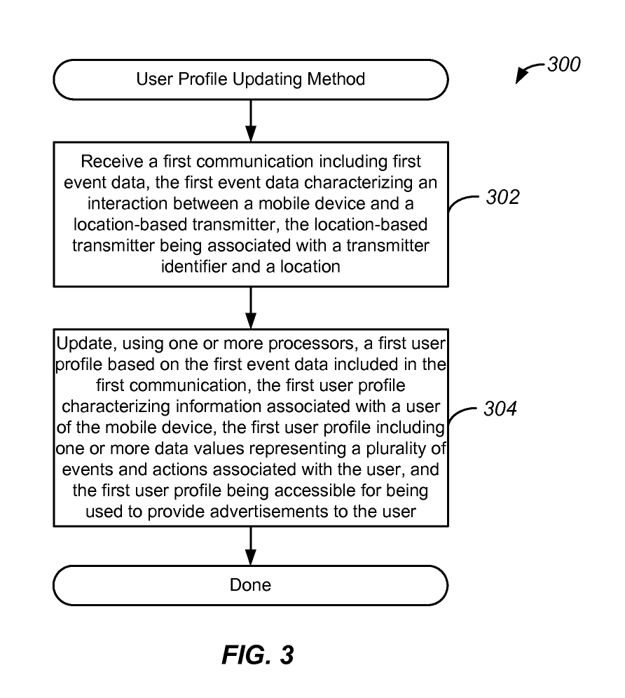

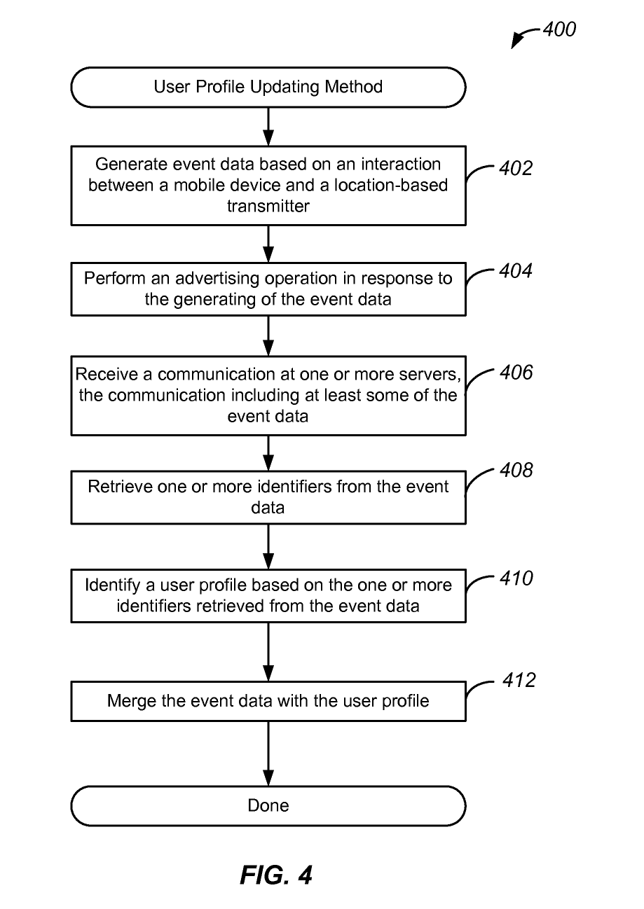

FIG. 3 illustrates a flow chart of an example of a user profile updating method, implemented in accordance with some embodiments. As similarly discussed above, a user of a mobile device may have an associated user profile stored and maintained by various servers such as advertisement servers and profile servers. The user profile may store various sequences of events and actions such as the viewing or advertisements, the purchases of products, and interactions with location-based transmitters. In various embodiments, a user profile updating method, such as method 300, may be implemented to augment the data included in the user profile with data characterizing offline events and actions performed by the user. In this way, offline activity may be correlated with online activity for a particular user, and a user profile may be updated to provide a unified view of the user's activities that includes both online and offline activity. As similarly discussed above, the data associated with the offline activity that is included in the user profile may include various geographical and positional data that characterizes the location of the user. As will be discussed in greater detail below with reference to FIGS. 4, 5, and 6, such data and inferences based on such data may be used perform one or more actions, such as implementing a campaign or sub-campaign specific to that user at that particular location.

Accordingly, method 300 may commence at operation 302, during which a communication may be received. According to some embodiments, the communication may be a message that is generated by a device located or positioned at the physical location of the user. For example, the communication may be generated by the user's mobile device, or may be generated by a component of a computing device used at a point-of-sale. The communication may include data or information that describes or characterizes the user's position or location, and activities associated with the user at that position or location. For example, the communication may include event data that characterizes an interaction between the mobile device and a location-based transmitter that may be near the user and the mobile device. In this example, the location-based transmitter may broadcast or transmit a signal with a unique identifier also referred to herein as a transmitter identifier. The transmitter identifier may be received by the mobile device during the interaction, and may be included in the communication that is generated and sent from the mobile device. The particular signal strength of the signal received from the transmitter can be correlated to a particular distance or distance range between the transmitter and mobile device, and this distance information (or raw strength data) can also be included in the communication that is generated and sent from the mobile device. A mobile device may receive multiple transmitter identifier signals at varying signal strengths from multiple transmitters. The communication may be received at a plurality of servers that includes the advertisement servers and/or profile servers discussed above with reference to FIG. 1.

During operation 304, the user's profile may be updated based on the information or data that was included in the communication. Thus, based on the information included in the communication, a particular user profile that is associated with the user may be identified. As discussed above, the user profile may include data largely aggregated from online activities such as online shopping and browsing. The event data included in the communication may be added to the user profile. In this way, the user's profile may be augmented and updated to include information that describes or characterizes the user's offline activities and locations associated with those activities. As will be discussed in greater detail below, the addition of this data to the user's profile may provide an expansive view of the user's activities that, among other things, enables a more effective and efficient implementation of advertisement campaigns directed at the user.

FIG. 4 illustrates a flow chart of an example of another user profile updating method, implemented in accordance with some embodiments. As similarly discussed above, a user profile updating method, such as method 400, may be used to correlate a user's offline activity with the user's online activity to provide a unified view of the user's activity, which may include one or more actions performed by the user. Thus, according to some embodiments, interactions between users and location-based transmitters may be recorded and included in their respective user profiles. Data describing such interactions may be combined with other events and actions included in their user profiles to form data objects that identify and characterize sequences of events that may include both offline and online user activity.

Accordingly, method 400 may commence at operation 402 during which event data may be generated based on an interaction between a mobile device and a location-based transmitter. A mobile device may establish a wireless connection with the location-based transmitter and may receive the transmitter identifier from the location-based transmitter. In various embodiments, the connection and data transfer between the mobile device and the location-based transmitter may be managed by a software application or component of an operating system executing on the mobile device. As similarly discussed above, a mobile device, such as a smartphone or tablet PC, may be configured (e.g., with an application or operating system) to periodically check for or detect the presence of location-based transmitters which may transmit a signal via a wireless communications interface. In various embodiments, the location-based transmitters may transmit the signal within a predetermined or designated distance, and such signal may be received by a mobile device at a particular signal strength that has been correlated to a particular distance or distance range. For example, a location-based transmitter may transmit a signal which includes a unique transmitter identifier within a maximum radius of 5 feet. In this example, if the mobile device is positioned 2.5 feet within a 5 foot maximum radius of the location-based transmitter, the mobile device may interact with the location-based transmitter by detecting the transmitter's broadcast signal at about half its maximum signal strength. The mobile device may also be configured to perform triangulation with respect to multiple signals from multiple transmitters to determine the mobile device's distance relative to each transmitter.

In response to detecting the presence of the location-based transmitter, the mobile device may generate event data that characterizes the interaction between the mobile device and the location-based transmitter. For example, a software application executing on the mobile device may generate a data object that includes the transmitter identifier associated with the location-based transmitter as well as various other metadata, such as distance and a time stamp indicating when the interaction occurred. Moreover, the data object may also include various other identifiers such as a device identifier associated with the mobile device and a unique identifier associated with software application. The various identifiers and metadata may be included in the event data and stored as part of the data object.

Method 400 may proceed to operation 404 during which an advertising operation may be performed in response to generating the event data. In some embodiments, the advertising operation may be the presentation of advertisement content to the user of the mobile device via a display device included in the mobile device. For example, an advertisement for a particular product may be displayed in response to the generation of the event data. In some embodiments, the advertisement may be selected by a software application on the mobile device based on the received transmitter identifier and distance of the mobile device from the transmitter. Thus, the mobile device may store in a local data store various advertisement content that may be mapped to or associated with various transmitter identifiers and/or distance. In this way, in response to receiving or detecting a transmitter identifier, the software application may select and display a particular advertisement that has been mapped locally on the mobile device to that particular transmitter identifier.

For example, a retail location may publish its own software application that the user of the mobile device may download and install on the mobile device. The software application may be configured to store advertisement content that may be provided by the retail location as well as a list of transmitter identifiers and/or distances associated with transmitters that are positioned or located in the retail physical location. Accordingly, when a particular transmitter identifier is detected, advertisement content associated with the transmitter identifier may be displayed. For example, a location-based transmitter may be positioned in a wine aisle of a grocery store. The location-based transmitter may be configured to transmit a signal over a distance co-extensive with the section of the aisle allocated to a particular vintner. In response to detecting the transmitter identifier associated with the location-based transmitter that is positioned in the wine aisle, the software application on the mobile device may identify a video file stored locally and present the user with the video file which may include additional information about that vintner. The advertisement content may also depend on the relative distance from the mobile device to the transmitter. For example, a location-based transmitter may be positioned immediately adjacent to a particular wine as well as within a particular aisle that may be allocated to a particular vintner. The mobile application may be configured to present content related to the particular wine when the detected transmitter identifier signal strength is within a particular maximum range, and may present content pertaining more generally to the particular vintner when the signal strength is not within the maximum range.

It will be appreciated that the advertising operation may include various other operations, such as the presentation of a coupon, the presentation of a video review, the presentation of a webpage displaying information about a product, or the presentation of a product recommendation. Moreover, according to some embodiments, operation 404 is optionally performed. Thus, in some embodiments, method 400 might not include operation 404, and no such operation might be performed by the software application executed on the mobile device.

Additionally, a particular transmitter identifier may be tied to particular advertisement content or to a particular item type (e.g., product type or brand) that is associated with particular content. For instance, a list of transmitter identifiers (and/or distances) may be associated with different content in a data store. In another embodiment, a data store may include a predefined list of transmitter identifiers associated with specific item types and a predefined list of item types associated with different content. For instance, three different location-based transmitted may be placed proximate to and associated with a same product (e.g., a specific television model) or same product type (e.g., televisions by brand X), either of which may be associated with particular content.

Method 400 may proceed to operation 406 during which a communication may be received at one or more servers. According to some embodiments, the communication may be a message that includes at least some of the event data. In various embodiments, the communication may be sent by the mobile device and may be received by various servers associated with a campaign services provider. For example, the software application executed on the mobile device may be configured to send the communication including the event data to the servers in response to the generating of the event data. In this way, event data may be provided automatically to the campaign services provider, and in a way that is dynamic and responsive to interactions between the mobile device and location-based transmitters.

In various embodiments the communication may be a request issued by the mobile device. For example, at least some of the content that may be displayed during operation 404 may include components which may be stored at an advertisement server. Accordingly, when the content is to be displayed at the mobile device, a request for the component which is stored remotely at the advertisement server may be issued by the software application of the mobile device. The component may be a text file, image, video file, or a tracking pixel. Thus, the request issued by the mobile device may be received at the servers, and identifiers associated with the request may be stored for future use.

Method 400 may proceed to operation 408 during which one or more identifiers may be retrieved from the event data. Accordingly, during operation 408, the contents of the communication may be processed to extract identifiers and associated metadata such as the device identifier associated with the mobile device, the transmitter identifier associated with the location-based transmitter, and time stamp associated with the interaction between the two.

Method 400 may proceed to operation 410 during which a user profile may be identified based on the one or more identifiers retrieved from the event data. In some embodiments, the campaign services provider may use its own set of unique identifiers, such as user identifiers, to identify users and their respective profiles. According to some embodiments, the user identifiers associated with the users may be different than the device identifiers associated with the mobile devices, or other identifiers which may be available, such as anonymous identifiers which may be available from the retail location and its respective mobile software application. Accordingly, the event data may be mapped to a user profile to correlate the user of the mobile device with an existing user and his or her user profile that is stored and maintained by the campaign services provider.

For example, the campaign services provider may already have stored a mobile device identifier associated with the user in each user profile. Thus, the device identifier included in the event data may be compared against device identifiers included in the user profiles, and a particular user profile may be identified based on a match. In some embodiments, if no user profile is identified, a new user profile may be generated and assigned a new user identifier.

Method 400 may proceed to operation 412 during which the event data may be merged with the user profile. Accordingly, once a user profile has been identified, the event data may be stored in one or more data objects associated with the user profile. In this way, the user profile may be updated to include event data which characterizes a recent interaction between the mobile device and a location-based transmitter. Returning to a previous example, if the user was presented with an informational video at a wine aisle of a grocery store, event data associated with the presentation of the video may be received and stored in a user profile associated with the user of the mobile device. Thus, the user's user profile may be updated to include data identifying which location the user was at, when, and what action or operation occurred at that time and location.

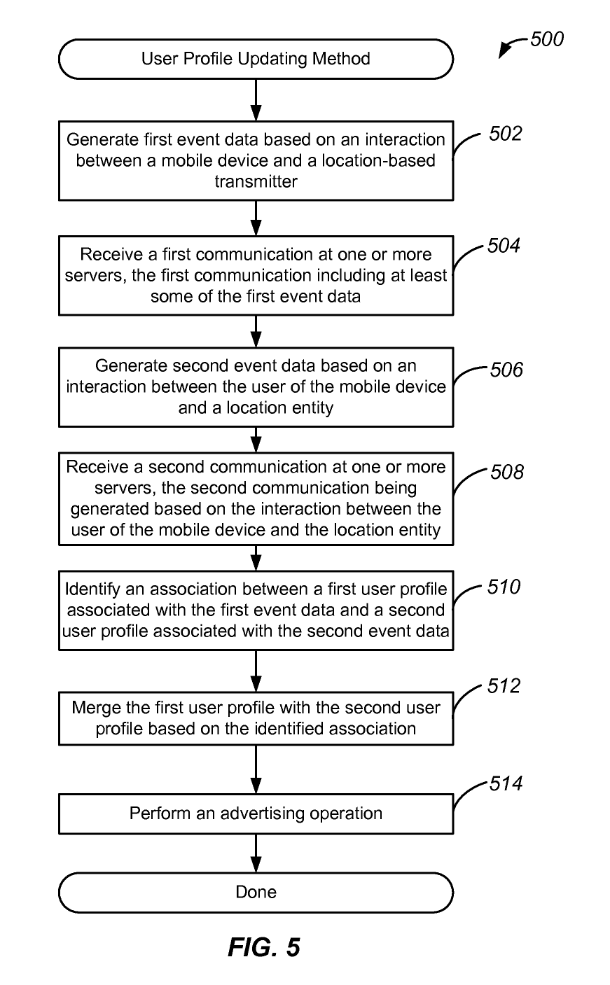

FIG. 5 illustrates a flow chart of an example of another user profile updating method, implemented in accordance with some embodiments. As similarly discussed above, a user profile updating method, such as method 500, may be used to correlate a user's offline activity with the user's online activity to provide a unified view of the user's activity. As discussed in greater detail below, multiple offline events received from or detected by different entities may be correlated and combined with a user profile to further augment the view of the user's activities, as well as the implementation of advertisement campaigns targeted at the user.

Accordingly, method 500 may commence with operation 502 during which first event data may be generated based on an interaction between a mobile device and a location-based transmitter. As similarly discussed above with reference to FIG. 4, a mobile device, such as a smartphone or tablet PC, may be configured to periodically check for or detect the presence of location-based transmitters which may transmit a signal via a wireless communications interface. In response detecting the presence of the location-based transmitter, the mobile device may generate event data that characterizes the interaction between the mobile device and the location-based transmitter. Accordingly, a software application executing on the mobile device may generate a data object that includes the transmitter identifier associated with the location-based transmitter as well as various other metadata, such as a distance and a time stamp indicating when the interaction occurred. Moreover, the data object may also include various other identifiers such as a device identifier associated with the mobile device and a unique identifier associated with software application. The various identifiers and metadata may be included in the event data and stored as part of the data object.

Method 500 may proceed to operation 504 during which a first communication may be received at one or more servers. The first communication may include the first event data. As similarly discussed above with reference to FIG. 4, the communication may be sent by the mobile device and may be received by various servers associated with a campaign services provider. For example, the software application executed on the mobile device may be configured to send the communication including the event data to the servers in response to the generating of the event data. In this way, event data may be provided automatically to the campaign services provider dynamically and responsive to interactions between the mobile device and location-based transmitters.

Method 500 may proceed to operation 506 during which second event data may be generated based on an interaction between the user of the mobile device and a location entity. In some embodiments, the second event data may be event data which describes or characterizes an interaction between the user, as well as his or her mobile device, and a another entity which may be a location entity that is located or positioned at the user's location. The location entity may or may not be communicatively coupled with one or more servers operated and maintained by the campaign services provider. In some embodiments, the location entity may be another or second location-based transmitter which may interact with the mobile device and may provide a second transmitter identifier which may be used to generate the second event data. In this example, the mobile device may generate the second event data as similarly described above with reference to the first event data.

According to some embodiments, the location entity may be one or more components of a point of sale. In various embodiments, a point of sale may be a position or location at which a commercial transaction occurs. For example, a location entity for a point of sale may be a wireless commerce console located in retail location and used by an employee to initiate and/or complete a commercial transaction with a customer who is shopping at the retail location. In this example, the commerce console may generate the second event data in response to the customer purchasing a product. Thus, the second event data may include a unique identifier associated with the customer. In some embodiments, the unique identifier may be generated by the retail location. Moreover, the second event data may also include a time stamp identifying the time and date of the transaction as well as one or more data values characterizing the transaction. For example, the second event data may include one or more data values identifying a type of transaction, such as a purchase, and an associated product, such as a product identifier that identifies a product that has been purchased. The second event data may be generated in response to the initiation and/or completion of the transaction.

In various embodiments, a location entity may be located at one or more other locations within a retail location. For example, a location entity may be one or more components of a data processing device or system which may be located at a point of entry, a point of exit, and/or a point of product interaction where a user or mobile device may interact with a product within a designated distance. In this way, a location entity may be positioned at various different physical locations within a retail location which may each be associated with a particular user activity such as entering a store, exiting a store, or viewing a product. Moreover, as similarly discussed above, the location entity may also be a location-based transmitter that may be positioned or located at a point of entry, a point of exit, and/or a point of product interaction.

Method 500 may proceed to operation 508 during which a second communication may be received at one or more servers. In some embodiments, the second communication may include at least some of the second event data. As similarly discussed above, the second communication may be sent by the mobile device in response to the second event data being generated, and the second communication may be received by various servers operated by a campaign services provider.

Alternatively, the second communication may be sent by a location entity based on an interaction or action that occurred at a particular location. Returning to a previous example, the second communication may be sent by a commerce console in response to a customer initiating the purchase of a product. Thus, the second communication may include various information describing or characterizing checkout activity associated with the user at a particular retail location. Furthermore, the second communication may include various information about the user, such as a unique identifier used by the retail location to identify and record the user's purchasing activities. In various embodiments, the location entity may be configured to generate and issue a communication or message to the servers operated by the campaign services provider in response to the checkout activity. Thus, the wireless commerce console may generate and send the second communication to the campaign services provider as part of the checkout process.

In various embodiments, the second communication may be a request that is issued by the location entity. According to various embodiments, the request may be a request for content associated with the checkout process. For example, the request may be for content that is displayed to the user during the checkout process on a checkout device or the user's mobile device. The content may be commercial or advertisement content that is displayed to the user at a user interface screen during the checkout process. In some embodiments, the requested content may include a tracking pixel associated with a campaign services provider. Accordingly, the requested content may be stored remotely at one or more servers operated by the campaign services provider. Thus, the campaign services provider may receive the request and various identifiers which may be included in the request that describe and characterize the user and the interaction or action associated with the user that is occurring at the location entity.

Method 500 may proceed to operation 510 during which an association between a first user profile and a second user profile may be identified. In some embodiments, the first user profile may be associated with the first event data and the second user profile may be associated with a second user profile. As previously discussed, a campaign services provider may store various data and information about a user as well as interactions associated with a user, such as advertisement views, click-throughs, and interactions with location-based transmitters. Such data and information may be stored in one or more user profiles. Thus, the various data and information may be associated with one or more user identifiers that may be used by the campaign services provider to identify users and data associated with the users.

In some embodiments, different interactions may be mapped to different user profiles because the campaign services provider might not have sufficient information to determine that the users associated with the different user profiles are the same person. For example, first event data may be associated with a mobile device, and may be mapped to and stored in a first user profile based on a mobile identifier included in the event data. Moreover, second event data may be associated with a purchase made at a point of sale, and may be mapped to and stored in a second user profile based on a personal identifier used by the retail location to identify the customer. In this example, the campaign services provider which manages both the first user profile and the second user profile might not know that the mobile device belongs to the user and that the first event data and the second event data are actually both associated with the same user.

Accordingly, one or more servers operated by the campaign services provider may be configured to identify an association between the first user profile and the second user profile. As discussed in greater detail below with reference to operation 512, once such an association has been identified, the data included in the first and second user profiles may be merged such that all available data associated with a user is represented in a single user profile. In various embodiments, a system component such as a control server may be configured correlate event data among different user profiles to identify an association between the profiles. For example, one or more servers operated by the campaign services provider may be configured to identify a correlation or a statistically significant similarity between time stamp data associated with various event data.

Returning to a previous example, a first time stamp may be associated with first event data that was generated based on an interaction between a mobile device and a location-based transmitter that is located at a point of sale. Moreover, a second time stamp may be associated with second event data that was generated by a component of the point of sale, such as a wireless console used to complete a commercial transaction. In various embodiments, one or more servers operated by the campaign services provider may be configured to identify a correlation or similarity between the first time stamp and the second time stamp if they occur, for example, within a designated amount of time from each other. For instance, if a checkout event occurs soon after a particular mobile device was identified in a first event as being proximate to a transmitter near the checkout area, it may be determined or inferred that the user of the particular mobile device is performing a checkout event. If such a correlation or similarly is determined, the identifiers associated with the first event data may be mapped to or associated with identifiers associated with the second event data. For example, a mobile identifier associated with the first event data may be mapped to the personal identifier that was associated with the second event data. As will be discussed in greater detail below, such an association may form the basis of merging the user profiles to associate them with a single user identifier used by the campaign services provider.

In another example, the first event data may be included in a first user profile associated with a first mobile device and the second event data may be included in a second user profile associated with a second mobile device. As previously discussed, one or more servers operated by the campaign services provider may be configured to identify an association between the first user profile and the second user profile based on a correlation or similarity between the first event data and the second event data. In this example, an association is also identified amongst mobile devices of the user. For example, if both the first user profile and the second user profile are actually associated with the same user, then the one or more servers may be configured to determine that both the first mobile device and the second mobile device both belong to the user. In this way, various embodiments described herein may identify several mobile devices that belong to a user based on various location-based event data associated with the user, and may map the mobile device identifiers to a single user identifier.

Method 500 may proceed to operation 512 during which the first user profile may be merged with the second user profile based on the identified association. In various embodiments, the first user profile and second user profile may be merged by updating a data table that includes one or more data fields configured to map related or associated user profiles to each other. For example, the data table may include several rows each configured to store several user profile identifiers. In this way, each row may store several user profile identifiers that identify related user profiles. Moreover, the data table may be configured to provide one or more links between data values stored within the data table. For example, each of the related user profile identifiers may be linked such that a request for a data field or data value stored in one user profile also requests the data field or data value stored in the other related user profiles. For example, a master user identifier may be created and associated with each merged user identifier and its event object. In this way, the mapping provided by the data table may be used to identify and retrieve related user profiles when data from one user profile is requested.

Furthermore, according to various embodiments, the related user profiles may be merged into a single data object which is then stored as a single merged data object that represents a merged user profile. In this way, a single data object may be updated to maintain and store data associated with the user.

Method 500 may proceed to operation 514 during which an advertising operation may be performed. In various the advertising operation may be an operation performed by a system component, such as a control server, to implement one or more components of an advertisement campaign. For example, the advertising operation may include the presentation of an advertisement to the user, the presentation of a message to the user, or a modification of a commercial transaction associated with the user. In this way, one or more components of an advertisement campaign may be implemented and targeted to a user based on data characterizing the user's “online” interactions and “offline” interactions at various locations, such as retail locations.

In one example, a coupon may be automatically applied to the user's purchase of a product based on one or more other interactions with location-based transmitters. In this example, the first event data may have been generated based on an interaction between the user's mobile device and a location-based transmitter which may have been positioned or located at an exit of a store. Thus, the user may have been exiting the store and been presented with a notification indicating that a particular product was now on sale. Such a notification may have been generated by the retail location, or may have been generated by the campaign services provider based on an advertisement campaign targeted at the user as well as other user profile event data that is available for the user. The notification may have been provided to the user's mobile device based on a detected interaction between the mobile device and the location-based transmitter. In response to receiving the notification, the user might not have exited the store, but instead gone back to purchase the product. When purchasing the product, second event data may have been generated that identifies the product being purchased. In response to receiving the second event data, a coupon may be applied to the purchase of the product, thus reducing the price of the product as advertised in the notification that was initially provided. For instance, a coupon that can be scanned at checkout may be presented on the user's device or a coupon may be applied directly on the checkout device that is being used to check out the particular user. In this way, an advertising operation may be performed based on available user profile data as well as event data characterizing interactions between the user and location-based transmitters.

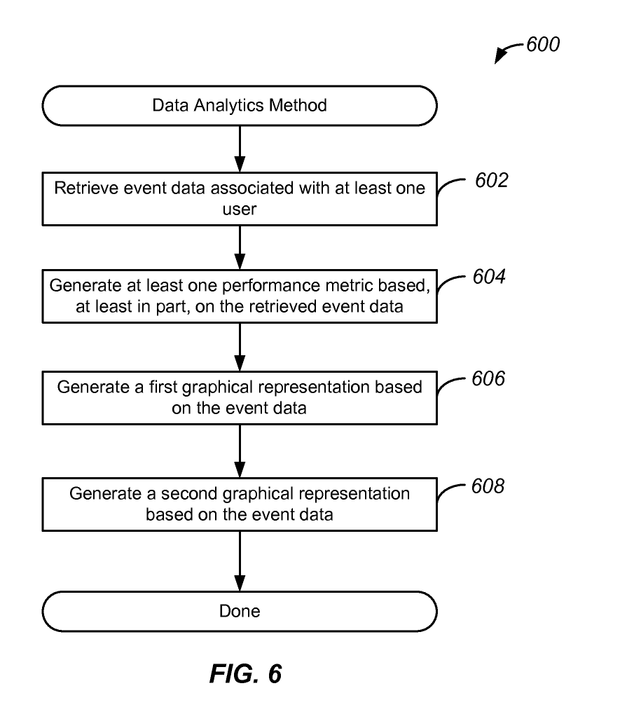

FIG. 6 illustrates a flow chart of an example of a data analytics method, implemented in accordance with some embodiments. According to various embodiments, in addition to updating user profiles and implementing advertisement campaigns based on the updated user profiles, various data, such as event data, may be analyzed to determine performance metrics associated with the advertisement campaigns as well as generate graphical representations of the advertisement campaigns and the underlying online and offline activity itself.

Method 600 may commence with operation 602 during which event data associated with at least one user may be retrieved. As previously discussed above, event data may be stored and maintained by a campaign services provider in one or more servers of a database system. In various embodiments, at operation 602 event data associated with various users may be identified and retrieved. In some embodiments, the event data may be identified based on any suitable characteristic or property associated with the event data. For example, the event data may be identified based on time stamp, geographical location, user profile identifier, retail location identifier, mobile device identifier, campaign identifier, or any combination of the previously mentioned characteristics and properties. Once identified, the event data may be retrieved by a system component, such as a control server, for subsequent analysis and use in operations 604-608 discussed in greater detail below.

Method 600 may proceed to operation 604 during which at least one performance metric may be generated based, at least in part, on the retrieved event data. As previously discussed, a campaign services provider may be an entity that provides services associated with various advertisement campaigns. In some embodiments, an advertisement campaign may include various sub-campaigns. The campaign may have a total budget which is allocated and distributed amongst the various sub-campaigns to, for example, submit bid requests for advertisements which may be presented to users targeted by the respective sub-campaigns. In some embodiments, the retrieved event data may be used, at least in part, to determine and generate a graphical representation of one or more performance metrics associated with an advertisement campaign and its associated sub-campaigns.

For example, a graphical representation of a return on investment may be generated for an advertisement campaign, and/or any of its associated sub-campaigns. In this example, the event data may include or be combined with various user profile data associated with various users targeted by the advertisement campaign. The event data may be identified based on a list of user identifiers targeted by the advertisement campaign. In some embodiments, the event data and user profile data may be extracted into sequences of events, some of which lead to an action, such as a click-through or a purchase of a product, and some of which did not. The various events included in each sequence of events may represent “online” interactions such as views of advertisements that were viewed through an internet browser, as well as “offline” interactions such as interactions between the user's mobile device and a location-based transmitter that occurred at a physical retail location. Similarly, actions may be “online” purchases or “offline” purchases.

In various embodiments, each event may have an associated cost and each action may have an associated value returned. In one example, a cost may be the cost of a bid request for an advertisement and a value returned may be a value associated with the purchase of a product. Thus, a system component, such as a control server, may be configured to calculate a cost and value returned for each extracted sequence of events, for each sub-campaign and advertisement campaign. In this way, a total cost and a total value returned may be calculated to determine a performance metric, such as a return on investment for a particular advertisement campaign. As previously discussed, the calculated return on investment is based on events that include both “online” activity, such the viewing of internet advertisements, as well as “offline” activity, such as being at a physical location or purchasing a product from a physical retail location. It will be appreciated that other metrics of value may be used as well, such as a click-through rate or the completion rate of any other desired action.

Method 600 may proceed to operation 606 during which a first graphical representation of the event data may be generated. According to various embodiments, one or more system components may be configured to generate a first graphical representation of based, at least in part, on the at least one performance metric that was generated during operation 604. In one example, the first graphical representation may be a graph that displays periodic calculations of a performance metric for an advertisement campaign over a period of time. In another example, the first graphical representation may be a bar graph that presents a side-by-side comparison of performance metrics for sub-campaigns included within an advertisement campaign. In various embodiments, a user may be presented with a user interface screen including one or more data fields configured to receive one or more inputs that may modify or adjust parameters associated with the first graphical representation. Accordingly, the generation of the first graphical representation may be user configurable, and may be generated based on or in response to one or more inputs provided by a user.

Method 600 may proceed to operation 608 during which a second graphical representation may be generated based on the event data. In some embodiments, the second graphical representation may be generated dynamically to provide a dynamic and “real-time” graphical representation of event data associated with one or more physical or geographical locations. Thus, the second graphical representation may be a “heat map” or real-time representation of activity at the physical or geographical locations. For example, event data generated at a particular retail location may be identified and retrieved at operation 602, and may be mapped to a graphical representation of the retail location, which may be a top view or floor plan of the retail location. In some embodiments, the mapping may be performed dynamically and in response to the generation of the event data at the retail location. According to various embodiments, the event data may be mapped to the graphical representation based on one or more transmitter identifiers included in the event data. For example, event data may be generated based on an interaction between a mobile device and a location-based transmitter. The location-based transmitter may be represented at a particular location in the graphical representation based on a known physical position within the retail location. Accordingly, the transmitter identifier included in the event data may be used to identify a location-based transmitter and map the event data to a portion or location of the graphical representation.

In some embodiments, a system component may be configured to process event data associated with multiple users and multiple mobile devices to generate the second graphical representation. In this way, multiple interactions between multiple users and multiple location-based transmitters at a retail location may be represented in the second graphical representation. In some embodiments, the event data may be represented according to a color coding scheme in which different colors represent different rates of interactions for each location-based transmitter. Thus, a rate of interactions may be calculated for each location-based transmitter based on a number of users or mobile devices the location-based transmitter interacts with within a designated period of time. Each calculated rate may be mapped to a color, and the color may be represented in the second graphical representation. The rates may be periodically recalculated to continually update the “heat map” included in the second graphical representation. It will be appreciated that while a color coding scheme has been described, any suitable representational scheme may be used.

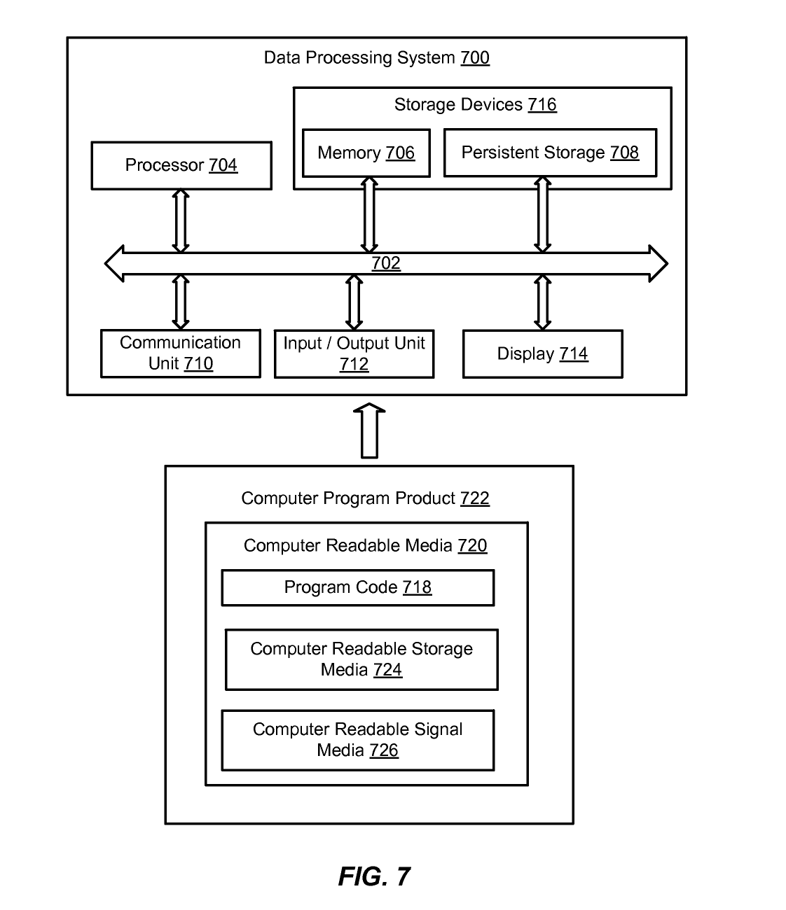

FIG. 7 illustrates a data processing system configured in accordance with some embodiments. Data processing system 700, also referred to herein as a computer system, may be used to implement one or more computers or processing devices used in a controller, server, or other components of systems described above. In some embodiments, data processing system 700 includes communications framework 702, which provides communications between processor unit 704, memory 706, persistent storage 708, communications unit 710, input/output (I/O) unit 712, and display 714. In this example, communications framework 702 may take the form of a bus system.

Processor unit 704 serves to execute instructions for software that may be loaded into memory 706. Processor unit 704 may be a number of processors, a multi-processor core, or some other type of processor, depending on the particular implementation.

Memory 706 and persistent storage 708 are examples of storage devices 716. A storage device is any piece of hardware that is capable of storing information, such as, for example, without limitation, data, program code in functional form, and/or other suitable information either on a temporary basis and/or a permanent basis. Storage devices 716 may also be referred to as computer readable storage devices in these illustrative examples. Memory 706, in these examples, may be, for example, a random access memory or any other suitable volatile or non-volatile storage device. Persistent storage 708 may take various forms, depending on the particular implementation. For example, persistent storage 708 may contain one or more components or devices. For example, persistent storage 708 may be a hard drive, a flash memory, a rewritable optical disk, a rewritable magnetic tape, or some combination of the above. The media used by persistent storage 708 also may be removable. For example, a removable hard drive may be used for persistent storage 708.

Communications unit 710, in these illustrative examples, provides for communications with other data processing systems or devices. In these illustrative examples, communications unit 710 is a network interface card.

Input/output unit 712 allows for input and output of data with other devices that may be connected to data processing system 700. For example, input/output unit 712 may provide a connection for user input through a keyboard, a mouse, and/or some other suitable input device. Further, input/output unit 712 may send output to a printer. Display 714 provides a mechanism to display information to a user.

Instructions for the operating system, applications, and/or programs may be located in storage devices 716, which are in communication with processor unit 704 through communications framework 702. The processes of the different embodiments may be performed by processor unit 704 using computer-implemented instructions, which may be located in a memory, such as memory 706.

These instructions are referred to as program code, computer usable program code, or computer readable program code that may be read and executed by a processor in processor unit 704. The program code in the different embodiments may be embodied on different physical or computer readable storage media, such as memory 706 or persistent storage 708.

Program code 718 is located in a functional form on computer readable media 720 that is selectively removable and may be loaded onto or transferred to data processing system 700 for execution by processor unit 704. Program code 718 and computer readable media 720 form computer program product 722 in these illustrative examples. In one example, computer readable media 720 may be computer readable storage media 724 or computer readable signal media 726.

In these illustrative examples, computer readable storage media 724 is a physical or tangible storage device used to store program code 718 rather than a medium that propagates or transmits program code 718.

Alternatively, program code 718 may be transferred to data processing system 700 using computer readable signal media 726. Computer readable signal media 726 may be, for example, a propagated data signal containing program code 718. For example, computer readable signal media 726 may be an electromagnetic signal, an optical signal, and/or any other suitable type of signal. These signals may be transmitted over communications links, such as wireless communications links, optical fiber cable, coaxial cable, a wire, and/or any other suitable type of communications link.

The different components illustrated for data processing system 700 are not meant to provide architectural limitations to the manner in which different embodiments may be implemented. The different illustrative embodiments may be implemented in a data processing system including components in addition to and/or in place of those illustrated for data processing system 700. Other components shown in FIG. 7 can be varied from the illustrative examples shown. The different embodiments may be implemented using any hardware device or system capable of running program code 718.

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatus. Accordingly, the present examples are to be considered as illustrative and not restrictive.

What is claimed is:

1. A method comprising:
receiving, at a control server, a first communication including first event data, the first event data characterizing an interaction between a mobile device and a location-based transmitter, the location-based transmitter being associated with a transmitter identifier and a location; and
updating, using one or more processors of the control server, a first user profile based on the first event data included in the first communication, the first user profile characterizing information associated with a user of the mobile device, the first user profile including one or more data values representing a plurality of online advertising events and actions associated with the user, the first user profile being accessible for being used to provide advertisements to the user, and the updating including merging the first event data characterizing the interaction between the mobile device and location-based transmitter with the plurality of online advertisement events and actions represented in the first user profile to generate a sequence of events associated with an advertisement campaign.

2. The method of claim 1, wherein the first event data includes a time stamp, the transmitter identifier, and a device identifier associated with the mobile device.

3. The method of claim 2, wherein the first event data is generated, at least in part, by an application executed on the mobile device, and wherein the first event data is generated in response to the mobile device being within a designated distance of the location-based transmitter.

4. The method of claim 3 further comprising:
mapping the device identifier and the transmitter identifier to the user profile.

5. The method of claim 1 further comprising:
receiving a second communication including second event data identifying an action associated with a point of sale, wherein the action is associated with a purchase transaction.

6. The method of claim 5, wherein the first event data is generated in response to the mobile device being within a designated distance of the location-based transmitter, wherein the location-based transmitter is located at the point of sale, and wherein the updating of the first user profile further comprises:
merging the first event data with the second event data based, at least in part, on a first set of identifiers associated with the first event data and a second set of identifiers associated with the second event data.

7. The method of claim 6 further comprising:
providing a third communication to the point of sale, the third communication including one or more data values capable of modifying the purchase transaction.

8. The method of claim 1 further comprising:
identifying a second user profile associated with the first user profile based on a correlation between second event data associated with the second user profile and the first event data associated with the first user profile; and
generating a merged profile by mapping one or more data fields of the first user profile to one or more data fields of the second user profile.

9. The method of claim 1 further comprising:
generating at least one performance metric based on the first user profile, the performance metric identifying one or more performance characteristics of an advertisement campaign associated with the first user profile.

10. The method of claim 9, wherein the performance metric identifies a return-on-investment associated with the advertisement campaign.

11. The method of claim 1 further comprising:
generating a graphical representation of the first event data, the graphical representation being capable of being displayed as a component of a user interface screen on a display device.

12. A system comprising:
one or more servers configured to store data associated with a plurality of users; and
one or more processors of a control server configured to execute one or more instructions to:
receive a first communication including first event data, the first event data characterizing an interaction between a mobile device and a location-based transmitter, the location-based transmitter being associated with a transmitter identifier and a location; and
update a first user profile based on the first event data included in the first communication, the first user profile characterizing information associated with a user of the mobile device, the first user profile including one or more data values representing a plurality of online advertising events and actions associated with the user, the first user profile being accessible for being used to provide advertisements to the user, and the updating including merging the first event data characterizing the interaction between the mobile device and location-based transmitter with the plurality of online advertisement events and actions represented in the first user profile to generate a sequence of events associated with an advertisement campaign.

13. The system of claim 12, wherein the first event data includes a time stamp, the transmitter identifier, and a device identifier associated with the mobile device.

14. The system of claim 13, wherein the first event data is generated, at least in part, by an application executed on the mobile device, and wherein the first event data is generated in response to the mobile device being within a designated distance of the location-based transmitter.

15. The system of claim 12, wherein the one or more processors are further configured to:
receive a second communication including second event data identifying an action associated with a point of sale, wherein the action is associated with a purchase transaction.

16. The system of claim 15, wherein the first event data is generated in response to the mobile device being within a designated distance of the location-based transmitter, wherein the location-based transmitter is located at the point of sale, and wherein the updating of the first user profile further comprises:
merging the first event data with the second event data based, at least in part, on a first set of identifiers associated with the first event data and a second set of identifiers associated with the second event data.

17. The system of claim 16, wherein the one or more processors are further configured to:
providing a third communication to the point of sale, the third communication including one or more data values capable of modifying the purchase transaction.

18. The system of claim 12, wherein the one or more processors are further configured to:
identify a second user profile associated with the first user profile based on a correlation between second event data associated with the second user profile and the first event data associated with the first user profile; and
generate a merged profile by mapping one or more data fields of the first user profile to one or more data fields of the second user profile.

19. One or more non-transitory computer readable media having instructions stored thereon for performing a method, the method comprising:
receiving a first communication including first event data, the first event data characterizing an interaction between a mobile device and a location-based transmitter, the location-based transmitter being associated with a transmitter identifier and a location; and
updating a first user profile based on the first event data included in the first communication, the first user profile characterizing information associated with a user of the mobile device, the first user profile including one or more data values representing a plurality of online advertising events and actions associated with the user, the first user profile being accessible for being used to provide advertisements to the user, and the updating including merging the first event data characterizing the interaction between the mobile device and location-based transmitter with the plurality of online advertisement events and actions represented in the first user profile to generate a sequence of events associated with an advertisement campaign.

20. The one or more non-transitory computer readable media recited in claim 19, the method further comprising:
receiving a second communication including second event data identifying an action associated with a point of sale, wherein the action is associated with a purchase transaction.
